(19) United States
(12) Patent Application Publication
(10) Pub. No.: US 2026/0214335 A1
(43) Pub. Date: Jul. 23, 2026

(54) OPTICAL IMAGING DEVICE

(71) Applicant: AAC Microtech (Changzhou) Co., Ltd., Changzhou City (CN)

(72) Inventors: Zhang Ren, Changzhou (CN); Wei Song, Changzhou (CN); Ronglin Linghu, Changzhou (CN)

(21) Appl. No.: 19/312,275

(22) Filed: Aug. 27, 2025

Related U.S. Application Data
(63) Continuation of application No. PCT/CN2025/073581, filed on Jan. 21, 2025.

(51) Int. Cl. H04N 23/68; H01F 7/08; H04N 23/51; H04N 23/54; H04N 23/55

(52) U.S. Cl. CPC H04N 23/687; H01F 7/081; H04N 23/51; H04N 23/54; H04N 23/55

(57) ABSTRACT

An optical imaging device is provided, including a housing having an accommodating space, a lens, an image sensor assembly, an elastic support component, and a driving assembly. The housing includes a top wall, a bottom wall, and a side wall, the top wall is disposed opposite to the bottom wall, the side wall is connected to the top wall and the bottom wall, and the top wall defines a through hole for communicating the accommodating space with an external environment. The lens is fixed to the top wall of the housing and covers the through hole. The image sensor assembly is disposed in the accommodating space, eliminating the need to provide additional movement space for a lens assembly. The image sensor assembly achieves precise displacement within a compact spatial envelope, thereby avoiding enlargement of a screen opening for the lens and effectively increasing a screen-to-body ratio.

### TECHNICAL FIELD

The present disclosure relates to the field of imaging devices, and in particular to an optical imaging device.

### BACKGROUND

Current cameras used in augmented reality (AR) glasses are constrained by size and weight limitations, adopting a fixed-focus design without optical image stabilization (OIS). Therefore, a compact OIS design is essential.

In conventional OIS solutions involving lens movement, a screen opening must be enlarged, adversely affecting a screen-to-body ratio. Additionally, such designs require reserved space within a housing body of an optical imaging device to accommodate lens movement, which hinders device miniaturization and fails to effectively control lateral dimensions of the optical imaging device.

Consequently, resolving these technical challenges has become an urgent issue to be addressed by those who skilled in the art.

### SUMMARY

Embodiments of the present disclosure aim to solve at least one technical problem in the related art by providing an optical imaging device.

In a first aspect, the embodiments of the present disclosure provides the optical imaging device, including a housing having an accommodating space, a lens, an image sensor assembly, an elastic support component, and a driving assembly. The housing includes a top wall, a bottom wall, and a side wall, the top wall is disposed opposite to the bottom wall, the side wall is connected to the top wall and the bottom wall, and the top wall defines a through hole for communicating the accommodating space with an external environment. The lens is fixed to the top wall of the housing and covers the through hole. The image sensor assembly is disposed in the accommodating space, the image sensor assembly includes an image sensor chip and a bracket, and the bracket is configured to support the image sensor chip. The elastic support component is disposed in the accommodating space, the elastic support component is connected to the bottom wall and the bracket, so as to suspend the image sensor assembly in the accommodating space. The driving assembly is disposed in the accommodating space, the driving assembly is at least partially overlapped with the image sensor chip when viewing along a direction of an optical axis of the lens, the driving assembly includes a magnetic circuit system and at least one driving coil disposed opposite to the magnetic circuit system, one of the at least one driving coil and the magnetic circuit system is fixed to bracket, another one of the at least one driving coil and the magnetic circuit system is fixed to the bottom wall of the housing, and the at least one driving coil and the magnetic circuit system cooperate to drive the image sensor assembly to move along a direction perpendicular to the optical axis of the lens.

As an improvement, the at least one driving coil is electrically connected to the elastic support component.

As an improvement, the magnetic circuit system includes a first magnetic circuit and a second magnetic circuit, the first magnetic circuit and the second magnetic circuit are overlapped along the direction of the optical axis of the lens, and the first magnetic circuit is closer to the at least one driving coil than the second magnetic circuit. The first magnetic circuit includes a first annular inner magnet and a first annular outer magnet, and the first annular inner magnet is spaced apart from the first annular outer magnet. The second magnetic circuit is an integrally magnetized magnet and includes a second annular inner magnet, a second annular outer magnet, and a non-magnetic portion, the second annular inner magnet is spaced apart from the second annular outer magnet, and the non-magnetic portion is disposed between the second annular inner magnet and the second annular outer magnet. Both the first annular inner magnet and the second annular inner magnet are magnetized along the direction of the optical axis of the lens, a magnetization direction of the first annular inner magnet is the same as a magnetization direction of the second annular inner magnet, both the first annular outer magnet and the second annular outer magnet are magnetized along the direction of the optical axis of the lens, a magnetization direction of the first annular outer magnet is the same as a magnetization direction of the second annular outer magnet, and the magnetization direction of the first annular inner magnet is opposite to the magnetization direction of the first annular outer magnet.

As an improvement, the magnetic circuit system includes the first magnetic circuit and the second magnetic circuit, the first magnetic circuit and the second magnetic circuit are overlapped along the direction of the optical axis of the lens, and the first magnetic circuit is closer to the at least one driving coil than the second magnetic circuit. The first magnetic circuit includes the first annular inner magnet and the first annular outer magnet, and the first annular inner magnet is spaced apart from the first annular outer magnet. The second magnetic circuit includes the second annular inner magnet and the second annular outer magnet, and the second annular inner magnet and the second annular outer magnet are interconnected. Both the first annular inner magnet and the second annular inner magnet are magnetized along the direction of the optical axis of the lens, the magnetization direction of the first annular inner magnet is the same as the magnetization direction of the second annular inner magnet, both the first annular outer magnet and the second annular outer magnet are magnetized along the direction of the optical axis of the lens, the magnetization direction of the first annular outer magnet is the same as the magnetization direction of the second annular outer magnet, and the magnetization direction of the first annular inner magnet is opposite to the magnetization direction of the first annular outer magnet.

As an improvement, the magnetic circuit system is an integrally magnetized magnet and includes an annular inner magnet, an annular outer magnet, and a non-magnetic portion, the annular outer magnet is spaced apart from the annular inner magnet, and the non-magnetic portion is disposed between the annular inner magnet and the annular outer magnet. Both the annular inner magnet and the annular outer magnet are magnetized along the direction of the optical axis of the lens, and a magnetization direction of the annular inner magnet is opposite to a magnetization direction of the annular outer magnet.

As an improvement, the magnetic circuit system is an integrally magnetized magnet and includes the annular inner magnet, the annular outer magnet, and an intermediate magnetic portion, and the intermediate magnetic portion is disposed between the annular inner magnet and the annular outer magnet. Both the annular inner magnet and the annular outer magnet are magnetized along the direction of the optical axis of the lens, and the magnetization direction of the annular inner magnet is opposite to the magnetization direction of the annular outer magnet. The intermediate magnetic portion is magnetized along the direction perpendicular to the optical axis of the lens, and a polarity of a surface of the intermediate magnetic portion close to the annular outer magnet is the same as a polarity of a surface of the annular outer magnet facing the lens.

As an improvement, the elastic support component includes a first connecting portion, a second connecting portion, and a third connecting portion. The first connecting portion is connected to the bottom wall of the housing, the second connecting portion is connected to the image sensor assembly, the third connecting portion is connected to both the first connecting portion and the second connecting portion, and the third connecting portion extends along the side wall of the housing. The first connecting portion is bent from the third connecting portion and extends along the bottom wall of the housing. The second connecting portion is bent from the third connecting portion and extends along a surface of the image sensor assembly.

As an improvement, the third connecting portion is frame-shaped, the first connecting portion is bent from an outer side of the third connecting portion and horizontally extends outward, and the second connecting portion is bent from an inner side of the third connecting portion and horizontally extends inward.

As an improvement, the third connecting portion is frame-shaped, both the first connecting portion and the second connecting portion are bent from the inner side of the third connecting portion and horizontally extend inward.

As an improvement, first reinforcing sheets are disposed at bent portions of at least one of the first connecting portion and the second connecting portion.

As an improvement, the third connecting portion is frame-shaped. The optical imaging device includes a second reinforcing sheet, the second reinforcing sheet is disposed at at least one of an inner side and an outer side of each of bent portions of the third connecting portion.

As an improvement, the bracket includes a frame and a circuit board, the frame is connected to the elastic support component, and the circuit board is disposed on the frame and electrically connected to the elastic support component. The image sensor chip is disposed on the circuit board and electrically connected thereto.

As an improvement, the bracket includes the frame and the circuit board, the frame is connected to the elastic support component, and the circuit board is disposed on the frame and electrically connected to the elastic support component. A side wall of the frame includes bent transition portions, the elastic support component is connected to the bent transition portions to suspend the frame in the accommodating space. The second connecting portion is bent from the third connecting portion at the bent transition portions and extends toward the optical axis of the lens.

As an improvement, the frame defines a mounting cavity at a first side thereof facing the bottom wall of the housing, and the mounting cavity is configured to accommodate the at least one driving coil or the magnetic circuit system. The frame further includes a support portion at a second side thereof facing the top wall of the housing, the support portion is configured to support the circuit board. The support portion and the mounting cavity are communicated through an opening, the first connecting portion is disposed at the opening, and a surface of the second connecting portion facing the circuit board is flush with a surface of the support portion.

As an improvement, the image sensor assembly further includes a filter and a support frame, the support frame is configured to support the filter. The filter is disposed between the lens and the image sensor chip, the support frame covers the image sensor chip and is disposed on the circuit board.

As an improvement, four driving coils are provided, each correspondingly spaced apart from the first magnetic circuit, and are circumferentially spaced along the first magnetic circuit. A winding hole of each of the four driving coils is disposed corresponding to a gap region between the first annular inner magnet and the first annular outer magnet.

As an improvement, the four driving coils are provided, each correspondingly spaced apart from the magnetic circuit system, and are circumferentially spaced along the magnetic circuit system. The winding hole of each of the four driving coils is disposed corresponding to the non-magnetic portion.

As an improvement, the four driving coils are provided, each correspondingly spaced apart from the magnetic circuit system, and are circumferentially spaced along the magnetic circuit system. The winding hole of each of the four driving coils is disposed corresponding to the intermediate magnetic portion.

Beneficial effects of the present disclosure are as follows.

In a fixed-focus optical image stabilization (OIS) design of the present disclosure, the image sensor assembly is adopted, eliminating the need to provide additional movement space for a lens assembly. The image sensor assembly achieves precise displacement within a compact spatial envelope, thereby avoiding enlargement of a screen opening for the lens and effectively increasing a screen-to-body ratio. Compared to conventional lens movement solutions, the driving assembly is at least partially overlapped with the image sensor chip of the image sensor assembly when viewing along the direction of the optical axis of the lens. Such configuration maximizes spatial utilization by sharing an axial space between the image sensor chip and the driving assembly. Consequently, lateral dimensions of the housing are significantly reduced, facilitating device miniaturization. Since the image sensor assembly directly moves perpendicular to the optical axis of the lens, a larger range of optical axis adjustment is achieved, thereby enabling a wider field of view (FOV) within the same screen opening dimensions.

### BRIEF DESCRIPTION OF DRAWINGS

FIG. 1 is a structural schematic diagram of an optical imaging device according to one embodiment of the present disclosure.

FIG. 2 is a cross-sectional schematic diagram taken along the line A-A shown in the optical imaging device of FIG. 1, in which a positional relationship between a driving assembly, an image sensor assembly, and a lens is illustrated.

FIG. 3 is a partial enlarged structural schematic diagram of the optical imaging device shown in FIG. 2.

FIG. 4 is an exploded three-dimensional schematic diagram of the optical imaging device.

FIG. 5 is a partial structural schematic diagram of the optical imaging device according to one embodiment of the present disclosure, in which a positional relationship between the driving assembly, an elastic support component, and an image sensor chip is illustrated.

FIG. 6 is an exploded three-dimensional schematic diagram of the optical imaging device.

FIG. 7 is a structural schematic diagram of the driving assembly according to one embodiment of the present disclosure.

FIG. 8 is an exploded three-dimensional schematic diagram of a magnetic circuit system according to one embodiment of the present disclosure.

FIG. 9 is a cross-sectional schematic diagram of the magnetic circuit system according to one embodiment of the present disclosure, in which a first magnetic circuit is configured in a split configuration, the second magnetic circuit is integrally formed using a quadrupole magnetization process, magnetization directions of a first annular inner magnet, a first annular outer magnet, a second annular inner magnet, and a second annular outer magnet are schematically indicated by arrows, and each of the arrows is defined as a direction from an S pole to an N pole.

FIG. 10 is a cross-sectional schematic diagram of the magnetic circuit system according to one embodiment of the present disclosure, in which the first magnetic circuit is configured in the split configuration, the second magnetic circuit is integrally formed using an assembly process, the magnetization directions of the first annular inner magnet, the first annular outer magnet, the second annular inner magnet, and the second annular outer magnet are schematically indicated by arrows, and each of the arrows is defined as the direction from the S pole to the N pole.

FIG. 11 is a cross-sectional schematic diagram of the magnetic circuit system according to one embodiment of the present disclosure, in which both the first magnetic circuit and the second magnetic circuit are integrally formed using a Halbach array process, magnetization directions of the first annular inner magnet, the first annular outer magnet, the second annular inner magnet, the second annular outer magnet, and an intermediate magnetic portion are schematically indicated by arrows, and each of the arrows is defined as the direction from the S pole to the N pole.

FIG. 12 is a cross-sectional schematic diagram of the magnetic circuit system according to one embodiment of the present disclosure, in which the magnetic circuit system is integrally formed using the quadrupole magnetization process, magnetization directions of an annular inner magnet and an annular outer magnet are schematically indicated by arrows, and each of the arrows is defined as the direction from the S pole to the N pole.

FIG. 13 is a cross-sectional schematic diagram of the magnetic circuit system according to one embodiment of the present disclosure, in which the magnetic circuit system is integrally formed using the Halbach array process, magnetization directions of the annular inner magnet, the annular outer magnet, and the intermediate magnetic portion are schematically indicated by arrows, and each of the arrows is defined as the direction from the S pole to the N pole.

FIG. 14 is a structural schematic diagram of the elastic support component according to one embodiment of the present disclosure.

FIG. 15 is an exploded three-dimensional schematic diagram of partial structures of the optical imaging device according to one embodiment of the present disclosure, in which a positional relationship between the image sensor chip, a frame, and a circuit board is illustrated.

FIG. 16 is a cross-sectional schematic diagram taken along line A-A shown in the optical imaging device of FIG. 1 according to another embodiment of the present disclosure, in which the positional relationship between the driving assembly, the image sensor assembly, and the lens are illustrated.

FIG. 17 is a partial enlarged structural schematic diagram of the optical imaging device shown in FIG. 16.

FIG. 18 is an exploded schematic diagram of the image sensor assembly, the elastic support component, and the driving assembly shown in FIG. 16.

FIG. 19 is an exploded three-dimensional schematic diagram of partial structures of the optical imaging device according to another embodiment of the present disclosure, in which the positional relationship between the image sensor chip, the frame, and the circuit board is illustrated.

FIG. 20 is a partial enlarged structural schematic diagram of the optical imaging device shown in FIG. 19.

FIG. 21 is a structural schematic diagram of the elastic support component and the driving assembly shown in FIG. 19.

FIG. 22 is an exploded three-dimensional schematic diagram of the image sensor assembly, the elastic support component, and the driving assembly shown in FIG. 19.

FIG. 23 is a structural schematic diagram of the magnetic circuit system shown in FIG. 19.

FIG. 24 is a three-dimensional schematic diagram of the elastic support component shown in FIG. 22.

FIG. 25 is a structural schematic diagram of a support frame shown in FIG. 4.

Reference numerals in the drawings: 100. optical imaging device; 10. housing; 20. lens; 30. image sensor assembly; 40. elastic support component; 50. driving assembly; 60. first reinforcing sheet; 70. second reinforcing sheet; 11. accommodating space; 12. top wall; 13. bottom wall; 14. side wall; 121. through hole; 21. optical axis; 31. image sensor chip; 32. bracket; 321. frame; 322. circuit board; 323. filter; 324. support frame; 3211. bent transition portion; 3212. mounting cavity; 3213. support portion; 3214. opening; 32131. surface of the support portion; 3241. accommodating cavity; 3242. support groove; 41. first connecting portion; 42. second connecting portion; 43. third connecting portion; 51. magnetic circuit system; 52. driving coil; 511. first magnetic circuit; 512. second magnetic circuit; 513. gap region; 5111. first annular inner magnet; 5112. first annular outer magnet; 5121. second annular inner magnet; 5122. second annular outer magnet; 5123. non-magnetic portion; 5124. joining portion; 514. annular inner magnet; 515. annular outer magnet; 516. intermediate magnetic portion; 521. winding hole.

### DETAILED DESCRIPTION OF EMBODIMENTS

To enable those who skilled in the art to better understand technical solutions of the present disclosure, the following detailed description is provided in conjunction with accompanying drawings and specific embodiments.

The following description, together with the accompanying drawings, is intended to illustrate implementation modes of the present disclosure in an exemplary manner. However, these descriptions and drawings are not to be construed as limiting a scope of the present disclosure. That is, the present disclosure is not limited to the embodiments specifically described herein. In the description of the present disclosure, it should be noted that, unless otherwise specified, a term "a plurality" means two or more. Directional terms, such as "upper", "lower", "left", "right", "inner", "outer", etc., are solely used for purpose of facilitating the description and simplifying the explanation of the present disclosure. These terms do not indicate or imply that referenced devices or components must be arranged in a specific orientation or configuration. Therefore, these terms should not be interpreted as limiting a scope of the present disclosure. Furthermore, terms "first", "second", etc. are solely used for a purpose of identification and description, and should not be interpreted as indicating or implying relative importance. A term "perpendicular" is not intended to mean strictly perpendicular, but rather within an allowable error range. Similarly, a term "parallel" is not intended to mean strictly parallel, but rather within an allowable error range.

Furthermore, in the description of the present disclosure, unless otherwise explicitly stated or defined, terms "mounted", "connected to", "connected with" etc. are to be interpreted in a broad sense. For example, such terms may refer to a fixed connection, a detachable connection, or an integral connection, and may also mean a direct connection or an indirect connection through one or more intermediate elements. For those who skilled in the art, specific meaning of these terms in the present disclosure may be understood according to a particular context and implementation.

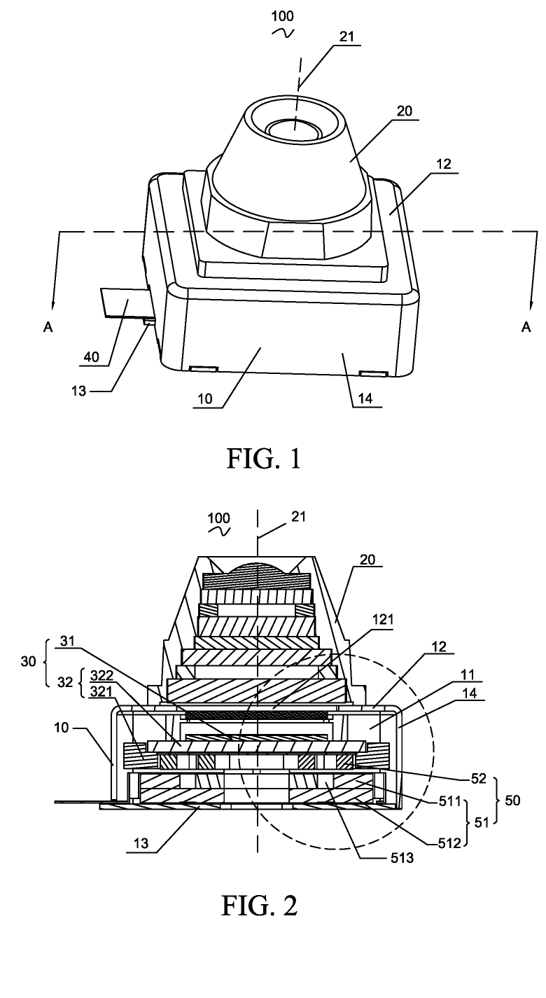

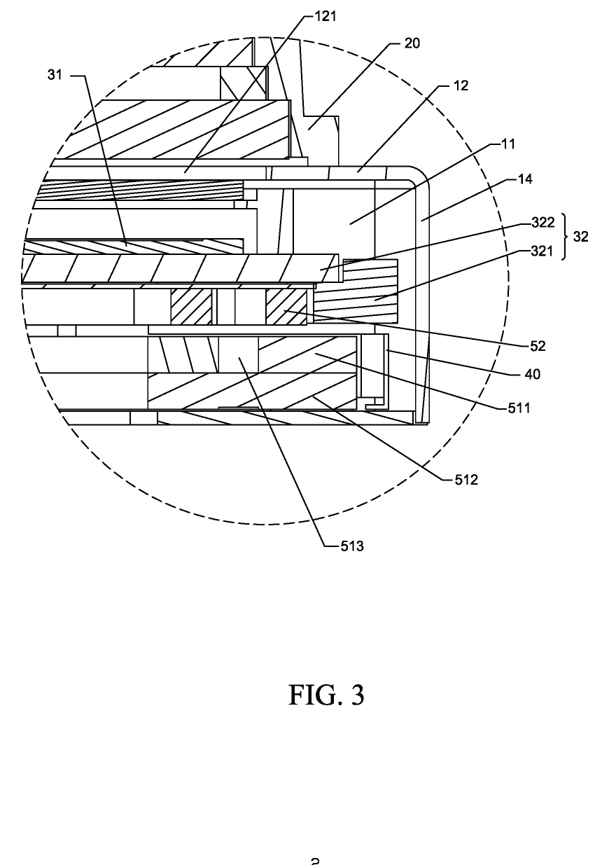

As shown in FIGS. 1-4, an optical imaging device 100 is provided, including a housing 10, a lens 20, an image sensor assembly 30, an elastic support component 40, and a driving assembly 50.

The housing 10 has an accommodating space 11 and includes a top wall 12, a bottom wall 13, and a side wall 14, the top wall 12 is disposed opposite to the bottom wall 13, the side wall 14 is connected to the top wall 12 and the bottom wall 13, and the top wall 12 defines a through hole 121 for communicating the accommodating space 11 with an external environment. The lens 20 is fixed to the top wall 12 of the housing 10 and covers the through hole 121.

The image sensor assembly 30 is disposed in the accommodating space 11, the image sensor assembly 30 includes an image sensor chip 31 and a bracket 32, and the bracket 32 is configured to support the image sensor chip 31.

The elastic support component 40 is disposed in the accommodating space 11, the elastic support component 40 is connected to the bottom wall 13 and the bracket 32, so as to suspend the image sensor assembly 30 in the accommodating space 11.

The driving assembly 50 is disposed in the accommodating space 11, the driving assembly 50 is at least partially overlapped with the image sensor chip 31 when viewing along a direction of an optical axis 21 of the lens 20, the driving assembly 50 includes a magnetic circuit system 51 and at least one driving coil 52 disposed opposite to the magnetic circuit system 51, one of the at least one driving coil 52 and the magnetic circuit system 51 is fixed to bracket 32, another one of the at least one driving coil 52 and the magnetic circuit system 51 is fixed to the bottom wall 13 of the housing 10, and the at least one driving coil 52 and the magnetic circuit system 51 cooperate to drive the image sensor assembly 30 to move along a direction perpendicular to the optical axis 21 of the lens 20.

In a fixed-focus optical image stabilization (OIS) design of the present disclosure, the image sensor assembly 30 is adopted, eliminating the need to provide additional movement space for a lens assembly. The image sensor assembly 30 achieves precise displacement within a compact spatial envelope, thereby avoiding enlargement of a screen opening 3214 for the lens 20 and effectively increasing a screen-to-body ratio. Compared to conventional lens movement solutions, the driving assembly 50 is at least partially overlapped with the image sensor chip 31 of the image sensor assembly 30 when viewing along the direction of the optical axis 21 of the lens 20. Such configuration maximizes spatial utilization by sharing an axial space between the image sensor chip 31 and the driving assembly 50. Consequently, lateral dimensions of the housing 10 are significantly reduced, facilitating device miniaturization. Since the image sensor assembly 30 directly moves perpendicular to the optical axis 21 of the lens 20, a larger range of optical axis adjustment is achieved, thereby enabling a wider field of view (FOV) within the same screen opening dimensions.

Specifically, an axis of the through hole 121 defined on the top wall 12 of the housing 10 is coaxial with the optical axis 21 of the lens 20. The image sensor assembly 30 is disposed along the direction of the optical axis 21 of the lens 20, supported by the elastic support component 40, and is positioned in correspondence with the lens 20.

In some embodiments, the at least one driving coil 52 is electrically connected to the elastic support component 40, and a circuit board 322 and the at least one driving coil 52 are electrically connected through the elastic support component 40.

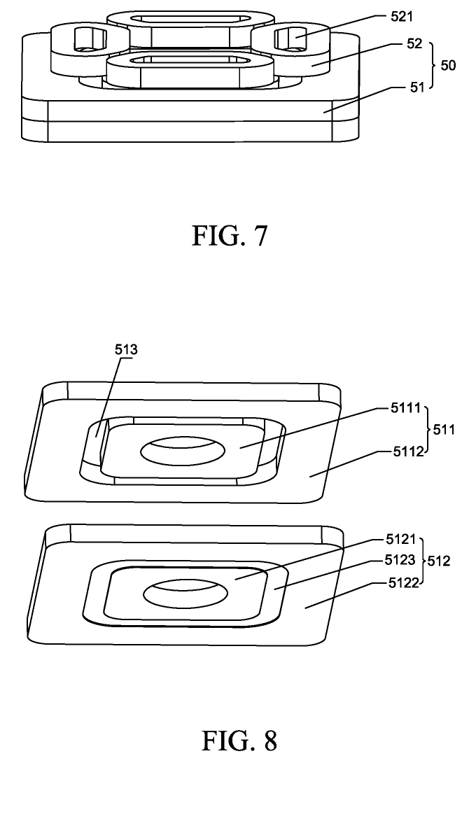

In some embodiments, as shown in FIGS. 7-8, the magnetic circuit system 51 includes a first magnetic circuit 511 and a second magnetic circuit 512, the first magnetic circuit 511 and the second magnetic circuit 512 are overlapped along the direction of the optical axis 21 of the lens 20, and the first magnetic circuit 511 is closer to the at least one driving coil 52 than the second magnetic circuit 512. The first magnetic circuit 511 includes a first annular inner magnet 5111 and a first annular outer magnet 5112, and the first annular inner magnet 5111 is spaced apart from the first annular outer magnet 5112. The second magnetic circuit 512 is an integrally magnetized magnet and includes a second annular inner magnet 5121, a second annular outer magnet 5122, and a non-magnetic portion 5123, the second annular inner magnet 5121 is spaced apart from the second annular outer magnet 5122, and the non-magnetic portion 5123 is disposed between the second annular inner magnet 5121 and the second annular outer magnet 5122.

Both the first annular inner magnet 5111 and the second annular inner magnet 5121 are magnetized along the direction of the optical axis 21 of the lens 20, a magnetization direction of the first annular inner magnet 5111 is the same as a magnetization direction of the second annular inner magnet 5121, both the first annular outer magnet 5112 and the second annular outer magnet 5122 are magnetized along the direction of the optical axis 21 of the lens 20, a magnetization direction of the first annular outer magnet 5112 is the same as a magnetization direction of the second annular outer magnet 5122, and the magnetization direction of the first annular inner magnet 5111 is opposite to the magnetization direction of the first annular outer magnet 5112.

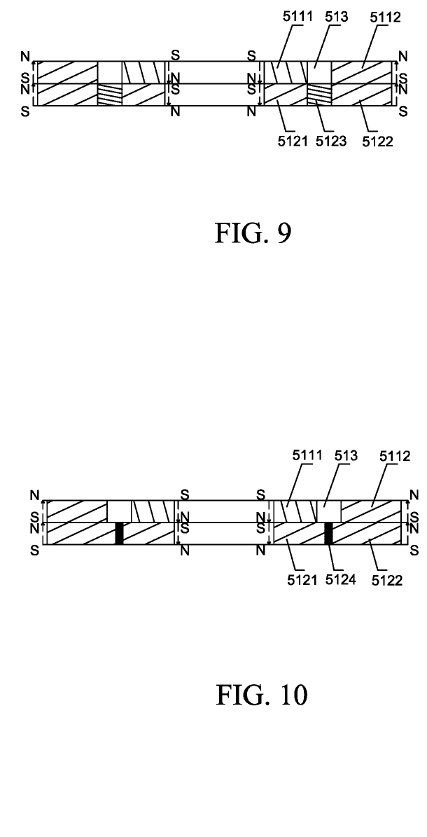

As shown in FIGS. 9-11, in one embodiment, both the first annular inner magnet 5111 and the second annular inner magnet 5121 are magnetized along the direction of the optical axis 21 of the lens 20, the magnetization direction of the first annular inner magnet 5111 is the same as the magnetization direction of the second annular inner magnet 5121, and both magnetization directions of the first annular inner magnet 5111 and the second annular inner magnet 5121 point toward the top wall 12 of the housing 10. It should be understood that the first magnetic circuit 511 is closer to the at least one driving coil 52 than the second magnetic circuit 52, along the direction of the optical axis 21 of the lens 20. Specifically, the first magnetic circuit 511 is disposed adjacent to the at least one driving coil 52 with a spacing therebetween, while the second magnetic circuit 512 is disposed away from the at least one driving coil 52 and disposed at one side of the first magnetic circuit 511 facing away from the at least one driving coil 52.

Specifically, a central axis of the first annular outer magnet 5112 coincides with a central axis of the first annular inner magnet 5111, thereby ensuring a more uniform magnetic field distribution between the first annular inner magnet 5111 and the first annular outer magnet 5112.

Furthermore, both the first annular inner magnet 5111 and the first annular outer magnet 5112 are of a rectangular ring shape. The first annular outer magnet 5112 defines a first rectangular inner space, and the first annular inner magnet 5111 defines a first circular inner space. The first annular inner magnet 5111 is disposed in the first rectangular inner space of the first annular outer magnet 5112. The first annular inner magnet 5111 and the first annular outer magnet 5112 together define a gap region 513 having a rectangular shape, and the rectangular shape of the gap region 513 corresponds to a position of the at least one driving coil 52.

Specifically, a central axis of the second annular inner magnet 5121 coincides with a central axis of the second annular outer magnet 5122, thereby ensuring a more uniform magnetic field distribution between the second annular inner magnet 5121 and the second annular outer magnet 5122.

Furthermore, both the second annular inner magnet 5121 and the second annular outer magnet 5122 are of the rectangular ring shape. The second annular outer magnet 5122 defines a second rectangular inner space, and the second annular inner magnet 5121 defines a second circular inner space. The second annular inner magnet 5121 is disposed in the second rectangular inner space of the second annular outer magnet 5122.

As shown in FIGS. 7 and 10, in some other embodiments, the magnetic circuit system 51 includes the first magnetic circuit 511 and the second magnetic circuit 512, the first magnetic circuit 511 and the second magnetic circuit 512 are overlapped along the direction of the optical axis 21 of the lens 20, and the first magnetic circuit 511 is closer to the at least one driving coil 52 than the second magnetic circuit 512. The first magnetic circuit 511 includes the first annular inner magnet 5111 and the first annular outer magnet 5112, and the first annular inner magnet 5111 is spaced apart from the first annular outer magnet 5112. The second magnetic circuit 512 includes the second annular inner magnet 5121 and the second annular outer magnet 5122, and the second annular inner magnet 5121 and the second annular outer magnet 5122 are interconnected.

Both the first annular inner magnet 5111 and the second annular inner magnet 5121 are magnetized along the direction of the optical axis 21 of the lens 20, the magnetization direction of the first annular inner magnet 5111 is the same as the magnetization direction of the second annular inner magnet 5121, both the first annular outer magnet 5112 and the second annular outer magnet 5122 are magnetized along the direction of the optical axis 21 of the lens 20, the magnetization direction of the first annular outer magnet 5112 is the same as the magnetization direction of the second annular outer magnet 5122, and the magnetization direction of the first annular inner magnet 5111 is opposite to the magnetization direction of the first annular outer magnet 5112.

Specifically, the second annular inner magnet 5121 and the second annular outer magnet 5122 are interconnected through a joining portion 5124, and the joining portion 5124 corresponds in position to the gap region 513 between the first annular inner magnet 5111 and the first annular outer magnet 5112.

Both the first annular inner magnet 5111 and the second annular inner magnet 5121 are magnetized along the direction of the optical axis 21 of the lens 20, the magnetization direction of the first annular inner magnet 5111 is the same as the magnetization direction of the second annular inner magnet 5121, and both magnetization directions of the first annular inner magnet 5111 and the second annular inner magnet 5121 point toward the bottom wall 13 of the housing 10. Both the first annular outer magnet 5112 and the second annular outer magnet 5122 are magnetized along the direction of the optical axis 21 of the lens 20, the magnetization direction of the first annular outer magnet 5112 is the same as the magnetization direction of the second annular outer magnet 5122, and both magnetization directions of the first annular outer magnet 5112 and the second annular outer magnet 5122 point toward the top wall 12 of the housing 10. It should be understood that the first magnetic circuit 511 is closer to the at least one driving coil 52 than the second magnetic circuit 52, along the direction of the optical axis 21 of the lens 20. Specifically, the first magnetic circuit 511 is disposed adjacent to the at least one driving coil 52 with a spacing therebetween, while the second magnetic circuit 512 is disposed away from the at least one driving coil 52 and disposed at the one side of the first magnetic circuit 511 facing away from the at least one driving coil 52.

In some embodiments, the first annular inner magnet 5111 and the first annular outer magnet 5112 are integrally formed using a quadrupole magnetization process. Specifically, along the direction of the optical axis 21 of the lens 20, a first end of the first annular inner magnet 5111 facing the top wall 12 of the housing 10 is magnetized as an S pole, while a second end of the first annular inner magnet 5111 facing away from the top wall 12 of the housing 10 is magnetized as an N pole. A first end of the first annular outer magnet 5112 facing the top wall 12 of the housing 10 is magnetized as an N pole, and a second end facing away from the top wall 12 of the housing 10 is magnetized as an S pole. A corresponding non-magnetic portion is disposed between the first annular inner magnet 5111 and the first annular outer magnet 5112. It should be understood that quadrupole magnetization refers to magnetizing magnets into four alternating magnetic poles (N-S-N-S), forming four distinct magnetic pole regions. Such configuration ensures a uniform magnetic field distribution in multiple directions, thereby reducing magnetic field distortion. Additionally, such multipole magnetic field may better cooperate with the at least one driving coil 52, generating a more concentrated electromagnetic force to improve driving efficiency and response speed. Furthermore, such configuration facilitates precise magnetic field control, which contributes to enhanced accuracy and stability in movement of the image sensor assembly 30.

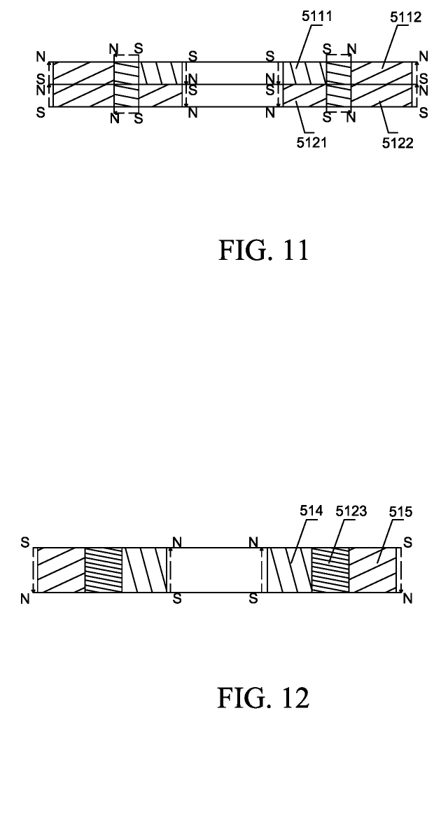

Referring to FIG. 11, in some embodiments, the first annular inner magnet 5111 and the first annular outer magnet 5112 are integrally formed using a Halbach array process. Specifically, along the direction of the optical axis 21 of the lens 20, the first end of the first annular inner magnet 5111 facing the top wall 12 of the housing 10 is magnetized as the S pole, while the second end of the first annular inner magnet 5111 facing away from the top wall 12 of the housing 10 is magnetized as the N pole. The first end of the first annular outer magnet 5112 facing the top wall 12 of the housing 10 is magnetized as the N pole, and the second end of the first annular outer magnet 5112 facing away from the top wall 12 of the housing 10 is magnetized as the S pole. A corresponding intermediate magnetic portion is disposed between the first annular inner magnet 5111 and the first annular outer magnet 5112, along the direction perpendicular to the optical axis 21 of the lens 20, a first end of the corresponding intermediate magnetic portion close to the first annular inner magnet 5111 is magnetized as an S pole, a second end of the corresponding intermediate magnetic portion close to the first annular outer magnet 5112 is magnetized as an N pole.

Referring to FIG. 9, in some embodiments, the second annular inner magnet 5121 and the second annular outer magnet 5122 are integrally formed using the quadrupole magnetization process. Specifically, along the direction of the optical axis 21 of the lens 20, a first end of the second annular inner magnet 5121 facing the first magnetic circuit 511 is magnetized as an S pole, while a second end of the second annular inner magnet 5121 facing away from the first magnetic circuit 511 is magnetized as an N pole. A first end of the second annular outer magnet 5122 facing the first magnetic circuit 511 is magnetized as an N pole, and a second end of the second annular outer magnet 5122 facing away from the first magnetic circuit 511 is magnetized as an S pole. Specifically, a corresponding non-magnetic portion 5123 is disposed between the second annular inner magnet 5121 and the second annular outer magnet 5122.

Please refer to FIG. 11, in some embodiments, the second annular inner magnet 5121 and the second annular outer magnet 5122 are integrally formed using the Halbach array process. Specifically, along the direction of the optical axis 21 of the lens 20, the first end of the second annular inner magnet 5121 facing the first magnetic circuit 511 is magnetized as the S pole, while the second end of the second annular inner magnet 5121 facing away from the first magnetic circuit 511 is magnetized as the N pole. The first end of the second annular outer magnet 5122 facing the first magnetic circuit 511 is magnetized as the N pole, and the second end of the second annular outer magnet 5122 facing away from the first magnetic circuit 511 is magnetized as the S pole. Specifically, a corresponding intermediate magnetic portion is disposed between the second annular inner magnet 5121 and the second annular outer magnet 5122, along the direction perpendicular to the optical axis 21 of the lens 20, a first end of the corresponding intermediate magnetic portion close to the second annular inner magnet 5121 is magnetized as an S pole, a second end of the corresponding intermediate magnetic portion close to the second annular outer magnet 5122 is magnetized as an N pole.

Referring to FIG. 12, in some embodiments, the magnetic circuit system 51 is an integrally magnetized magnet and includes an annular inner magnet 514, an annular outer magnet 515, and a corresponding non-magnetic portion 5123, the annular outer magnet 515 is spaced apart from the annular inner magnet 514, and the corresponding non-magnetic portion 5123 is disposed between the annular inner magnet 514 and the annular outer magnet 515. Both the annular inner magnet 514 and the annular outer magnet 515 are magnetized along the direction of the optical axis 21 of the lens 20, and a magnetization direction of the annular inner magnet 514 is opposite to a magnetization direction of the annular outer magnet 515.

In one embodiment of the present disclosure, the annular inner magnet 514 is magnetized along the direction of the optical axis 21 of the lens 20, and the magnetization direction of the annular inner magnet 514 points toward the top wall 12 of the housing 10, the annular outer magnet 515 is magnetized along the direction of the optical axis 21 of the lens 20, and the magnetization direction of the annular outer magnet 515 points toward the bottom wall 13 of the housing 10.

In some embodiments, the annular inner magnet 514 and the annular outer magnet 515 are integrally formed using the quadrupole magnetization process. Specifically, along the direction of the optical axis 21 of the lens 20, a first end of the annular inner magnet 514 facing the top wall 12 of the housing 10 is magnetized as an N pole, while a second end of the annular inner magnet 514 facing away from the top wall 12 of the housing 10 is magnetized as an S pole. A first end of the annular outer magnet 515 facing the top wall 12 of the housing 10 is magnetized as an S pole, and a second end of the annular outer magnet 515 facing away from the top wall 12 of the housing 10 is magnetized as an N pole. Specifically, the corresponding non-magnetic portion 5123 is disposed between the annular inner magnet 514 and the annular outer magnet 515.

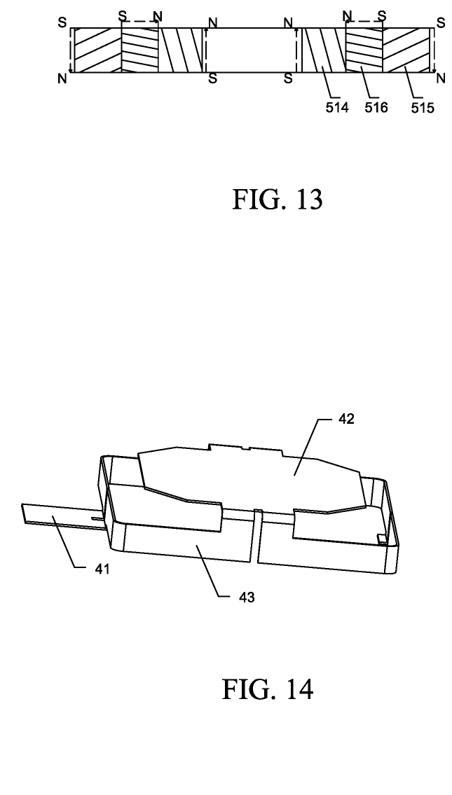

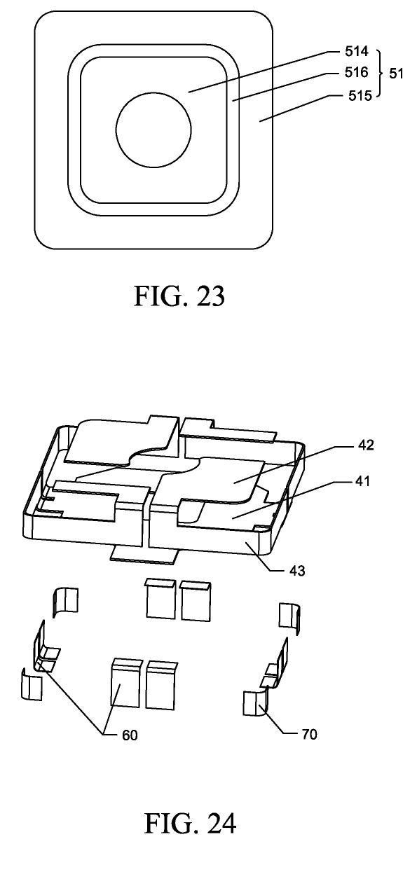

Referring to FIGS. 13 and 23, in some embodiments, the magnetic circuit system 51 is an integrally magnetized magnet and includes the annular inner magnet 514, the annular outer magnet 515, and a corresponding intermediate magnetic portion 516, and the corresponding intermediate magnetic portion 516 is disposed between the annular inner magnet 514 and the annular outer magnet 515. Both the annular inner magnet 514 and the annular outer magnet 515 are magnetized along the direction of the optical axis 21 of the lens 20, and the magnetization direction of the annular inner magnet 514 is opposite to the magnetization direction of the annular outer magnet 515. The corresponding intermediate magnetic portion 516 is magnetized along the direction perpendicular to the optical axis 21 of the lens 20, and a polarity of a surface of the corresponding intermediate magnetic portion 516 close to the annular outer magnet 515 is the same as a polarity of a surface of the annular outer magnet 515 facing the lens 20.

In one embodiment of the present disclosure, the annular inner magnet 514 is magnetized along the direction of the optical axis 21 of the lens 20, and the magnetization direction of the annular inner magnet 514 points toward the top wall 12 of the housing 10, the annular outer magnet 515 is magnetized along the direction of the optical axis 21 of the lens 20, and the magnetization direction of the annular outer magnet 515 points toward the bottom wall 13 of the housing 10. The corresponding intermediate magnetic portion 516 is magnetized along the direction perpendicular to the optical axis 21 of the lens 20, and the polarity of the surface of the corresponding intermediate magnetic portion 516 close to the annular outer magnet 515 is the same as the polarity of the surface of the annular outer magnet 515 facing the lens 20. Specifically, a magnetization direction of the corresponding intermediate magnetic portion 516 points toward the annular inner magnet 514 from the annular outer magnet 515.

Specifically, the annular inner magnet 514 and the annular outer magnet 515 are integrally formed using the Halbach array process. Specifically, along the direction of the optical axis 21 of the lens 20, the first end of the annular inner magnet 514 facing the top wall 12 of the housing 10 is magnetized as the N pole, while the second end of the annular inner magnet 515 facing away from the top wall 12 of the housing 10 is magnetized as the S pole. The first end of the annular outer magnet 515 facing the top wall 12 of the housing 10 is magnetized as the S pole, and the second end of the annular outer magnet 515 facing away from the top wall 12 of the housing 10 is magnetized as the N pole. Specifically, the corresponding intermediate magnetic portion 516 is disposed between the annular inner magnet 514 and the annular outer magnet 515, along the direction perpendicular to the optical axis 21 of the lens 20, a first end of the corresponding intermediate magnetic portion 516 close to the annular inner magnet 514 is magnetized as an N pole, a second end of the corresponding intermediate magnetic portion 516 close to the annular outer magnet 515 is magnetized as an S pole.

In some embodiments, the first annular inner magnet 5111 and the first annular outer magnet 5112 of the first magnetic circuit 511 are configured in a split configuration, the second annular inner magnet 5121 and the second annular outer magnet 5122 of the second magnetic circuit 512 are configured in the split configuration. It is understood that, the first annular inner magnet 5111 and the first annular outer magnet 5112 of the first magnetic circuit 511 are configured in the split configuration, specifically, the first annular inner magnet 5111 and the first annular outer magnet 5112 are individually fabricated and then assembled to form the first magnetic circuit 511. Similarly, the second annular inner magnet 5121 and the second annular outer magnet 5122 of the second magnetic circuit 512 are also configured in the split configuration, and the second annular inner magnet 5121 and the second annular outer magnet 5122 are individually fabricated and then assembled to form the second magnetic circuit 512.

In some embodiments, the first annular inner magnet 5111 and the first annular outer magnet 5112 of the first magnetic circuit 511 are configured in the split configuration, the second annular inner magnet 5121 and the second annular outer magnet 5122 of the second magnetic circuit 512 are configured in the split configuration. It is understood that the second magnetic circuit 512 is integrally formed using the quadrupole magnetization process, or is integrally formed by a joining process using a joining portion 5124.

In some embodiments, the first annular inner magnet 5111 and the first annular outer magnet 5112 of the first magnetic circuit 511 are configured in the split configuration, the second annular inner magnet 5121 and the second annular outer magnet 5122 of the second magnetic circuit 512 are configured in the split configuration. It is understood that both the first magnetic circuit and the second magnetic circuit 512 are integrally formed using the quadrupole magnetization process, or is integrally formed using the Halbach array process.

Referring to FIGS. 14 and 24, in some embodiments, the elastic support component 40 includes a first connecting portion 41, a second connecting portion 42, and a third connecting portion 43. The first connecting portion 41 is connected to the bottom wall 13 of the housing 10, the second connecting portion 42 is connected to the image sensor assembly 30, the third connecting portion 43 is connected to both the first connecting portion 41 and the second connecting portion 42, and the third connecting portion 43 extends along the side wall 14 of the housing 10. The first connecting portion 41 is bent from the third connecting portion 43 and extends along the bottom wall 13 of the housing 10. The second connecting portion 42 is bent from the third connecting portion 43 and extends along a surface of the image sensor assembly 30.

Specifically, the first connecting portion 41 is bent from a lower edge of the third connecting portion 43 and extends along an upper surface of the bottom wall 14 of the housing 10, the second connecting portion 42 is bent from an upper edge of the third connecting portion 43 and extends along a lower surface of the circuit board 322, the third connecting portion 43 is configured to either abut against the side wall 14 of the housing 10 or extend along the optical axis 21 of the lens 20 while being spaced apart from the side wall 14 of the housing 10 by a predetermined distance.

Referring to FIG. 14, in some embodiments, the third connecting portion 43 is frame-shaped, the first connecting portion 41 is bent from an outer side of the third connecting portion 43 and horizontally extends outward (i.e., away from a frame interior), and the second connecting portion 42 is bent from an inner side of the third connecting portion 43 and horizontally extends inward (i.e., toward the frame interior). It is understood that the inner side of the third connecting portion 43 refers to a first side of the third connecting portion 43 facing the frame interior, and the outer side of the third connecting portion 4 refers to a second side of the third connecting portion 43 facing a frame exterior.

In one embodiment of the present disclosure, the third connecting portion 43 is configured as a rectangular frame-shaped structure. The first connecting portion 41 and the second connecting portion 42 are both plate-shaped. The first connecting portion 41 is bent from the outer side of the third connecting portion 43 and horizontally extends outward, terminating at a connection with the bottom wall 13 of the housing 10. Meanwhile, the second connecting portion 42 is bent from the inner side of the third connecting portion 43 and horizontally extends inward, terminating at a connection with the lower surface of the circuit board 322.

Referring to FIG. 24, in some embodiments, the third connecting portion 43 is frame-shaped, both the first connecting portion 41 and the second connecting portion 42 are bent from the inner side of the third connecting portion 43 and horizontally extend inward.

In one embodiment of the present disclosure, the third connecting portion 43 is configured as the rectangular frame-shaped structure. The first connecting portion 41 and the second connecting portion 42 are both plate-shaped. The first connecting portion 41 is bent from the lower edge of the third connecting portion 43 and horizontally extends inward, terminating at the connection with the bottom wall 13 of the housing 10. Meanwhile, the second connecting portion 42 is bent from the upper edge of the third connecting portion 43 and horizontally extends inward, terminating at the connection with the lower surface of the circuit board 322.

Referring to FIGS. 22 and 24, in some embodiments, first reinforcing sheets 60 are disposed at bent portions of at least one of the first connecting portion 41 and the second connecting portion 42. Each of the first reinforcing sheets 60 has a curvature matching a curvature of a corresponding one of the bent portions of the at least one of the first connecting portion 41 and the second connecting portion 42.

In one embodiment of the present disclosure, the first reinforcing sheets 60 are disposed at the bent portions of the first connecting portion 41, configured to enhance structural integrity of the bent portions of the first connecting portion 41.

In another embodiment of the present disclosure, the first reinforcing sheets 60 are disposed at the bent portions of the second connecting portion 42, configured to enhance structural integrity of the bent portions of the second connecting portion 42.

In another embodiment of the present disclosure, the first reinforcing sheets 60 are respectively disposed at the bent portions of the first connecting portion 41 and the bent portions of the second connecting portion 42, configured to enhance structural integrity of the bent portions of the first connecting portion 41 and the bent portions of the second connecting portion 42.

In some embodiments, the third connecting portion 43 is frame-shaped. The optical imaging device 100 includes a second reinforcing sheet 70, the second reinforcing sheet 70 is disposed at at least one of an inner side and an outer side of each of bent portions of the third connecting portion 43. It is understood that, the third connecting portion 43 configured as the rectangular frame-shaped structure includes four bent portions along a perimeter thereof.

In one embodiment of the present disclosure, the second reinforcing sheet 70 is disposed at the inner side of each of the bent portions of the third connecting portion 43, configured to enhance structural integrity of the bent portions of the third connecting portion 43.

In another embodiment of the present disclosure, the second reinforcing sheet 70 is disposed at the outer side of each of the bent portions of the third connecting portion 43, configured to enhance structural integrity of the bent portions of the third connecting portion 43.

In another embodiment of the present disclosure, the second reinforcing sheet 70 is disposed at each of the inner side and the outer side of each of the bent portions of the third connecting portion 43, configured to enhance structural integrity of the bent portions of the third connecting portion 43.

In some embodiments, the bracket 32 includes a frame 321 and the circuit board 322, the frame 321 is connected to the elastic support component 40, and the circuit board 322 is disposed on the frame 321 and electrically connected to the elastic support component 40. The image sensor chip 31 is disposed on the circuit board 322 and electrically connected thereto.

Alternatively, in some embodiments, only the circuit board 322 is provided and serves as a support bracket. A first side of the circuit board 322 is electrically connected to the elastic support component 40, while a second side of the circuit board 322 opposite to the first side supports the image sensor chip 31. Such configuration serves to electrically connect the image sensor chip 31 to the elastic support component 40 and suspend the image sensor chip 31 in the accommodating space 11.

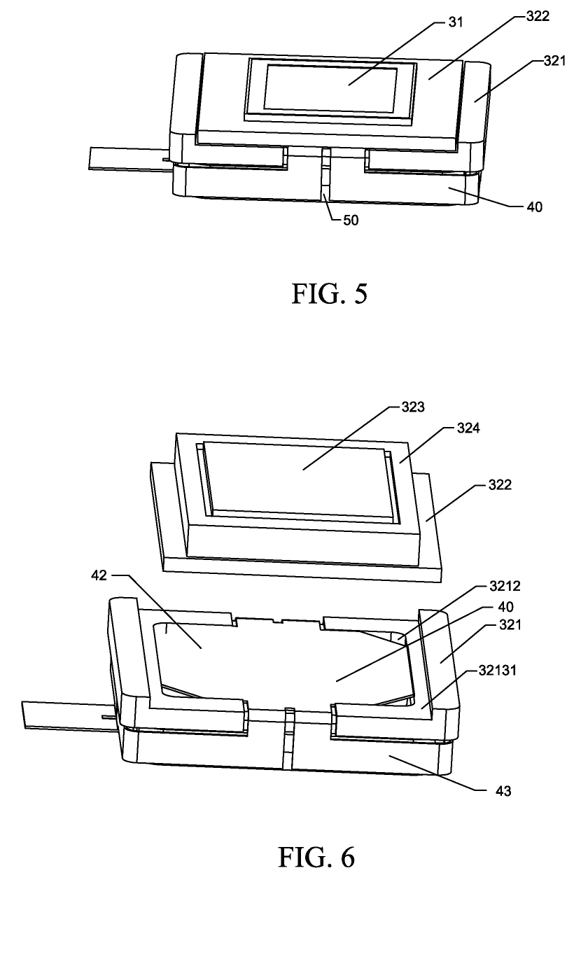

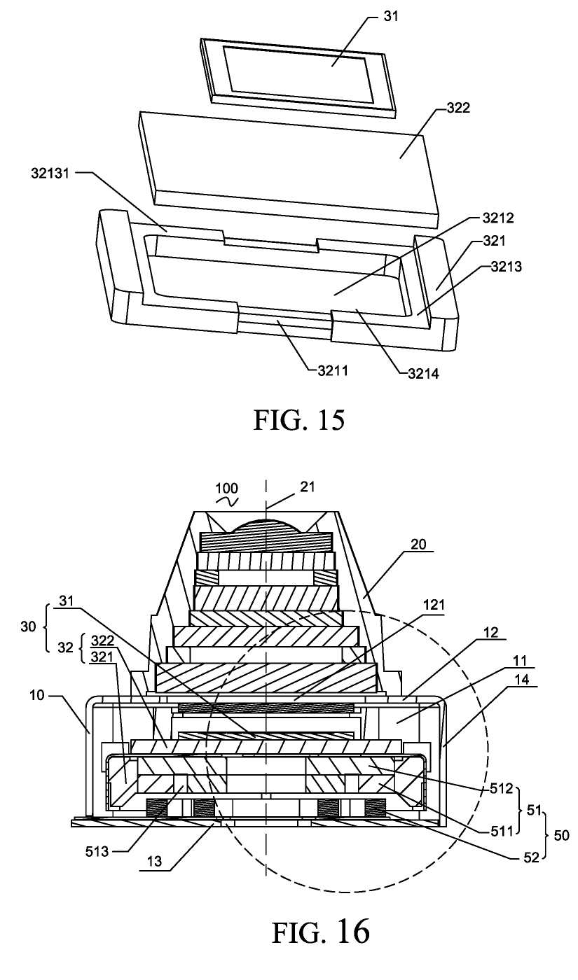

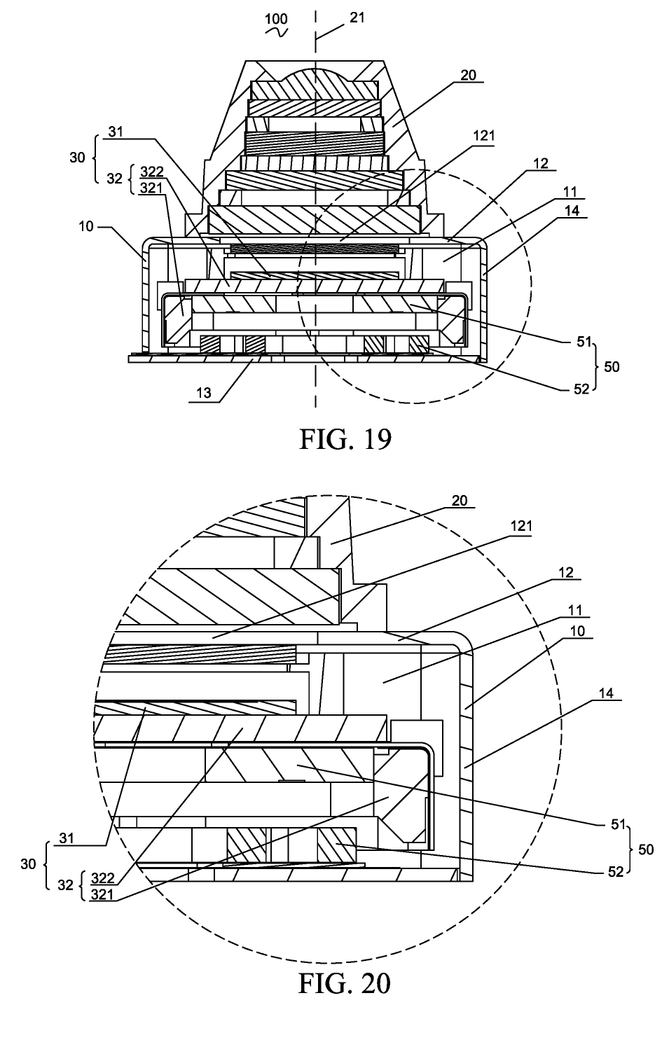

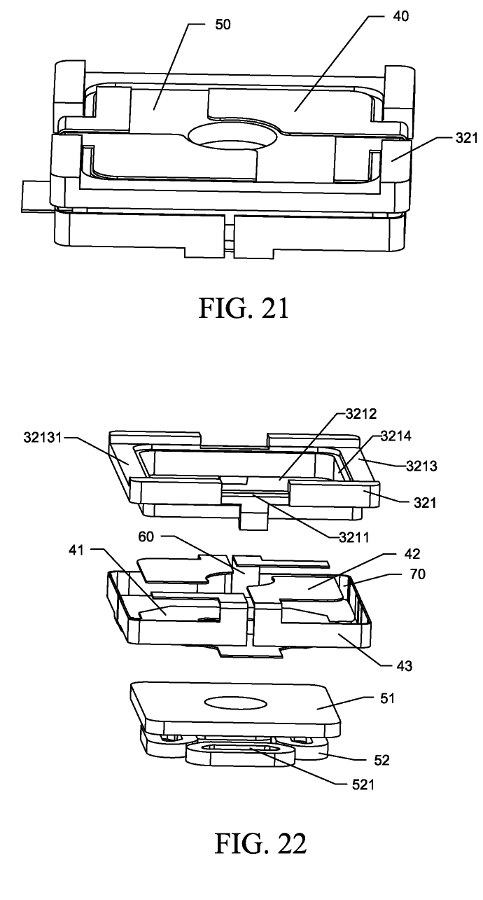

Referring to FIGS. 5, 15, 19, and 21, in one embodiment of the present disclosure, the bracket 32 includes the frame 321 and the circuit board 322, the frame 321 is connected to the elastic support component 40, and the circuit board 322 is disposed on the frame 321 and electrically connected to the elastic support component 40.

A side wall 14 of the frame 321 includes bent transition portions 3211, the elastic support component 40 is connected to the bent transition portions 3211 to suspend the frame 321 in the accommodating space 11. The second connecting portion 42 is bent from the third connecting portion 43 at the bent transition portions 3211 and extends toward the optical axis 21 of the lens 20. Specifically, a curvature of each of the bent transition portions 3211 matches a curvature of a corresponding one of the bent portions of the second connection portion 42.

In some embodiments, the frame 321 defines a mounting cavity 3212 at a first side thereof facing the bottom wall 13 of the housing 10, and the mounting cavity 3212 is configured to accommodate the at least one driving coil 52 or the magnetic circuit system 51. The frame 321 further includes a support portion 3213 at a second side thereof facing the top wall 12 of the housing 10, the support portion 3213 is configured to support the circuit board 322. The support portion 3213 and the mounting cavity 3212 are communicated through an opening 3214, the first connecting portion 41 is disposed at the opening 3214, and a surface of the second connecting portion 42 facing the circuit board 322 is flush with a surface 32131 of the support portion 3213.

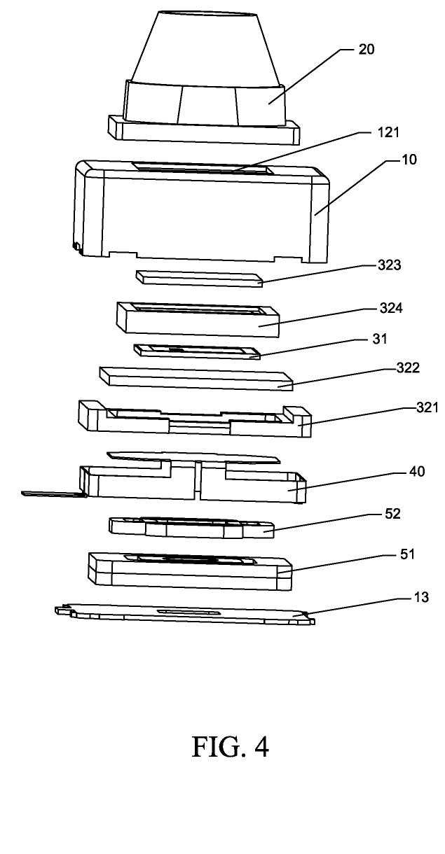

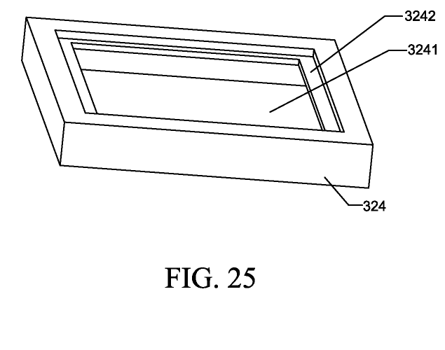

Referring to FIGS. 4 and 25, in some embodiments, the image sensor assembly 30 further includes a filter 323 and a support frame 324, the support frame 324 is configured to support the filter 323. The filter 323 is disposed between the lens 20 and the image sensor chip 31, the support frame 324 covers the image sensor chip 31 and is disposed on the circuit board 322.

Specifically, the support frame 324 includes an accommodating cavity 3241 and a support groove 3242, the accommodating cavity 3241 is configured to accommodate the image sensor chip 31, and the support groove 3242 is configured to accommodate the filter 323. The accommodating cavity 3241 is communicated with the support groove 3242 through a cavity opening of the accommodating cavity 3241, and a dimension of the support groove 3242 matches a dimension of the filter 323. Along the optical axis 21 of the lens 20, a projection of the support frame 324 fully overlaps a projection of the image sensor chip 31 and a projection of the filter 323.

In some embodiments, four driving coils 52 are provided, each correspondingly spaced apart from the first magnetic circuit 511, and are circumferentially spaced along the first magnetic circuit 511. A winding hole 521 of each of the four driving coils 52 is disposed corresponding to a gap region 513 between the first annular inner magnet 5111 and the first annular outer magnet 5112.

Referring to FIGS. 5-7 and 14, in one embodiment of the present disclosure, along the optical axis 21 of the lens 20, the magnetic circuit system 51 and the at least one driving coil 52 are spaced apart and disposed in the mounting cavity 3212 of the frame 321. Specifically, an upper surface of the second connecting portion 42 of the elastic support component 40 is electrically connected to the circuit board 322, and a lower surface of the second connecting portion 42 is electrically connected to the at least one driving coil 52. The magnetic circuit system 51 is disposed on the bottom wall 13 of the housing 10. The driving assembly 50 includes the four driving coils 52 and the magnetic circuit system 51 being ring-shaped, each of the four driving coils 52 is correspondingly spaced apart from the first magnetic circuit 511, and the four driving coils 52 are circumferentially spaced along the first magnetic circuit 511. The winding hole 521 of each of the four driving coils 52 is disposed corresponding to the gap region 513 between the first annular inner magnet 5111 and the first annular outer magnet 5112.

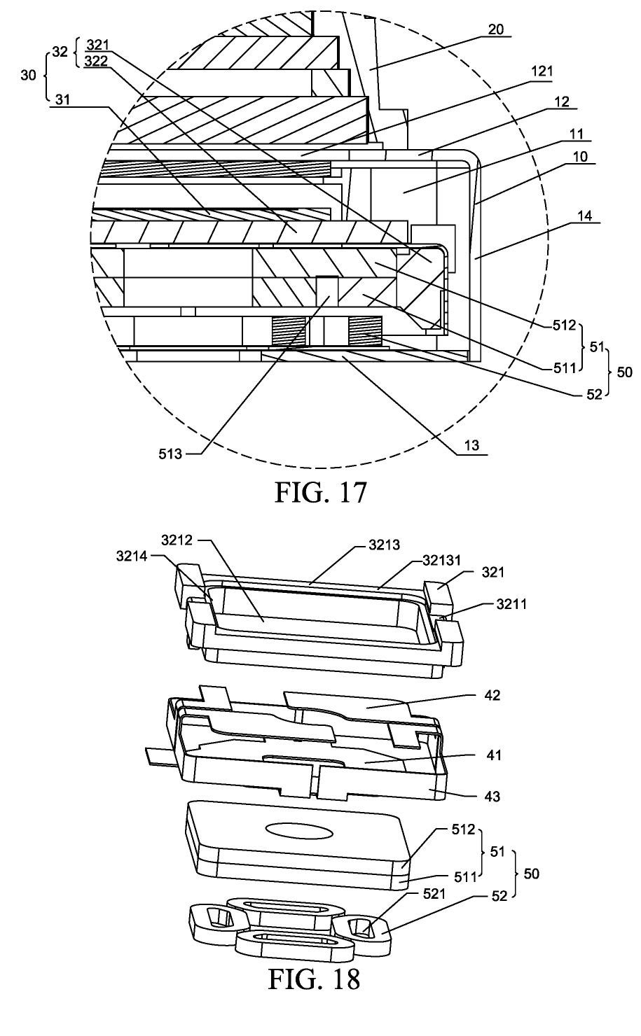

Referring to FIGS. 16-18, in one embodiment of the present disclosure, along the optical axis 21 of the lens 20, the magnetic circuit system 51 and the at least one driving coil 52 are spaced apart and disposed in the mounting cavity 3212 of the frame 321. Specifically, the upper surface of the second connecting portion 42 of the elastic support component 40 is electrically connected to the circuit board 322, and the magnetic circuit system 51 is disposed on the lower surface of the second connecting portion 42. The at least one driving coil 52 is disposed on an upper surface of the first connecting portion 41 of the elastic support component 40, so as to electrically connect to the circuit board 322 through the elastic support component 40. The driving assembly 50 includes the four driving coils 52 and the magnetic circuit system 51 being ring-shaped, each of the four driving coils 52 is correspondingly spaced apart from the first magnetic circuit 511, and the four driving coils 52 are circumferentially spaced along the first magnetic circuit 511. The winding hole 521 of each of the four driving coils 52 is disposed corresponding to the gap region 513 between the first annular inner magnet 5111 and the first annular outer magnet 5112.

In another embodiment of the present disclosure, along the optical axis 21 of the lens 20, the magnetic circuit system 51 and the at least one driving coil 52 are spaced apart and disposed in the mounting cavity 3212 of the frame 321. Specifically, the upper surface of the second connecting portion 42 of the elastic support component 40 is electrically connected to the circuit board 322, and the lower surface of the second connecting portion 42 is electrically connected to the at least one driving coil 52. The magnetic circuit system 51 is disposed on the bottom wall 13 of the housing 10. The driving assembly 50 includes the four driving coils 52 and the magnetic circuit system 51 being ring-shaped, each of the four driving coils 52 is correspondingly spaced apart from the first magnetic circuit 511, and the four driving coils 52 are circumferentially spaced along the first magnetic circuit 511. The winding hole 521 of each of the four driving coils 52 is disposed corresponding to both the gap region 513 between the first annular inner magnet 5111 and the first annular outer magnet 5112 and the joining portion 5124 (as shown in FIG. 10) between the second annular inner magnet 5121 and the second annular outer magnet 5122.

In another embodiment of the present disclosure, along the optical axis 21 of the lens 20, the magnetic circuit system 51 and the at least one driving coil 52 are spaced apart and disposed in the mounting cavity 3212 of the frame 321. Specifically, the upper surface of the second connecting portion 42 of the elastic support component 40 is electrically connected to the circuit board 322, and the magnetic circuit system 51 is disposed on the lower surface of the second connecting portion 42. The at least one driving coil 52 is disposed on the upper surface of the first connecting portion 41 of the elastic support component 40, so as to electrically connected to the circuit board 322 through the elastic support component 40. The driving assembly 50 includes the four driving coils 52 and the magnetic circuit system 51 being ring-shaped, each of the four driving coils 52 is correspondingly spaced apart from the first magnetic circuit 511, and the four driving coils 52 are circumferentially spaced along the first magnetic circuit 511. The winding hole 521 of each of the four driving coils 52 is disposed corresponding to both the gap region 513 between the first annular inner magnet 5111 and the first annular outer magnet 5112 and the joining portion 5124 (as shown in FIG. 10) between the second annular inner magnet 5121 and the second annular outer magnet 5122.

In some embodiments, the four driving coils 52 are provided, each correspondingly spaced apart from the magnetic circuit system 51, and are circumferentially spaced along the magnetic circuit system 51. The winding hole 521 of each of the four driving coils 52 is disposed corresponding to the non-magnetic portion 5123.

In one embodiment of the present disclosure, along the optical axis 21 of the lens 20, the magnetic circuit system 51 and the at least one driving coil 52 are spaced apart and disposed in the mounting cavity 3212 of the frame 321. Specifically, the upper surface of the second connecting portion 42 of the elastic support component 40 is electrically connected to the circuit board 322, and the lower surface of the second connecting portion 42 is electrically connected to the at least one driving coil 52. The magnetic circuit system 51 is disposed on the bottom wall 13 of the housing 10. The driving assembly 50 includes the four driving coils 52 and the magnetic circuit system 51 being ring-shaped, each of the four driving coils 52 is correspondingly spaced apart from the magnetic circuit system 51, and the four driving coils 52 are circumferentially spaced along the magnetic circuit system 51. The winding hole 521 of each of the four driving coils 52 is disposed corresponding to the non-magnetic portion 5123 between the annular inner magnet 514 and the annular outer magnet 515.

Referring to FIGS. 20-22, in another embodiment of the present disclosure, along the optical axis 21 of the lens 20, the magnetic circuit system 51 and the at least one driving coil 52 are spaced apart and disposed in the mounting cavity 3212 of the frame 321. Specifically, the upper surface of the second connecting portion 42 of the elastic support component 40 is electrically connected to the circuit board 322, and the magnetic circuit system 51 is disposed on the lower surface of the second connecting portion 42. The at least one driving coil 52 is disposed on the upper surface of the first connecting portion 41 of the elastic support component 40, so as to electrically connected to the circuit board 322 through the elastic support component 40. The driving assembly 50 includes the four driving coils 52 and the magnetic circuit system 51 being ring-shaped, each of the four driving coils 52 is correspondingly spaced apart from the magnetic circuit system 51, and the four driving coils 52 are circumferentially spaced along the magnetic circuit system 51. The winding hole 521 of each of the four driving coils 52 is disposed corresponding to the non-magnetic portion 5123 between the annular inner magnet 514 and the annular outer magnet 515.

In some embodiments, the four driving coils 52 are provided, each correspondingly spaced apart from the magnetic circuit system 51, and are circumferentially spaced along the magnetic circuit system 51. The winding hole 521 of each of the four driving coils 52 is disposed corresponding to the intermediate magnetic portion 516.

In one embodiment of the present disclosure, along the optical axis 21 of the lens 20, the magnetic circuit system 51 and the at least one driving coil 52 are spaced apart and disposed in the mounting cavity 3212 of the frame 321. Specifically, the upper surface of the second connecting portion 42 of the elastic support component 40 is electrically connected to the circuit board 322, and the lower surface of the second connecting portion 42 is electrically connected to the at least one driving coil 52. The magnetic circuit system 51 is disposed on the bottom wall 13 of the housing 10. The driving assembly 50 includes the four driving coils 52 and the magnetic circuit system 51 being ring-shaped, each of the four driving coils 52 is correspondingly spaced apart from the magnetic circuit system 51, and the four driving coils 52 are circumferentially spaced along the magnetic circuit system 51. The winding hole 521 of each of the four driving coils 52 is disposed corresponding to the intermediate magnetic portion 516 between the annular inner magnet 514 and the annular outer magnet 515.

In another embodiment of the present disclosure, along the optical axis 21 of the lens 20, the magnetic circuit system 51 and the at least one driving coil 52 are spaced apart and disposed in the mounting cavity 3212 of the frame 321. Specifically, the upper surface of the second connecting portion 42 of the elastic support component 40 is electrically connected to the circuit board 322, and the magnetic circuit system 51 is disposed on the lower surface of the second connecting portion 42. The at least one driving coil 52 is disposed on the upper surface of the first connecting portion 41 of the elastic support component 40, so as to electrically connected to the circuit board 322 through the elastic support component 40. The driving assembly 50 includes the four driving coils 52 and the magnetic circuit system 51 being ring-shaped, each of the four driving coils 52 is correspondingly spaced apart from the magnetic circuit system 51, and the four driving coils 52 are circumferentially spaced along the magnetic circuit system 51. The winding hole 521 of each of the four driving coils 52 is disposed corresponding to the intermediate magnetic portion 516 between the annular inner magnet 514 and the annular outer magnet 515.

A flexible circuit board is printed on the elastic support component 40, enabling the elastic support component 40 to conduct electrical current from the image sensor assembly 30 to the at least one driving coil 52.

In a second aspect, the embodiments of the present disclosure provides augmented reality (AR) glasses, the AR glasses include the optical imaging device 100 as foregoing.

It should be understood that the embodiments are merely exemplary implementations intended to illustrate principles of the present disclosure. However, the present disclosure is not limited thereto. For those who skilled in the art, various modifications and improvements may be made without departing from spirit and essence of the present disclosure, and such modifications and improvements shall also fall within a projection scope of the present disclosure.

What is claimed is:

1. An optical imaging device, comprising:
a housing having an accommodating space;
a lens;
an image sensor assembly;
an elastic support component; and
a driving assembly;
wherein the housing comprises a top wall, a bottom wall, and a side wall, the top wall is disposed opposite to the bottom wall, the side wall is connected to the top wall and the bottom wall, and the top wall defines a through hole for communicating the accommodating space with an external environment;
wherein the lens is fixed to the top wall of the housing and covers the through hole;
wherein the image sensor assembly is disposed in the accommodating space, the image sensor assembly comprises an image sensor chip and a bracket, and the bracket is configured to support the image sensor chip;
wherein the elastic support component is disposed in the accommodating space, the elastic support component is connected to the bottom wall and the bracket, so as to suspend the image sensor assembly in the accommodating space;
wherein the driving assembly is disposed in the accommodating space, the driving assembly is at least partially overlapped with the image sensor chip when viewing along a direction of an optical axis of the lens, the driving assembly comprises a magnetic circuit system and at least one driving coil disposed opposite to the magnetic circuit system, one of the at least one driving coil and the magnetic circuit system is fixed to bracket, another one of the at least one driving coil and the magnetic circuit system is fixed to the bottom wall of the housing, and the at least one driving coil and the magnetic circuit system cooperate to drive the image sensor assembly to move along a direction perpendicular to the optical axis of the lens.

2. The optical imaging device according to claim 1, wherein the at least one driving coil is electrically connected to the elastic support component.

3. The optical imaging device according to claim 1, wherein the magnetic circuit system comprises a first magnetic circuit and a second magnetic circuit, the first magnetic circuit and the second magnetic circuit are overlapped along the direction of the optical axis of the lens, and the first magnetic circuit is closer to the at least one driving coil than the second magnetic circuit;
the first magnetic circuit comprises a first annular inner magnet and a first annular outer magnet, and the first annular inner magnet is spaced apart from the first annular outer magnet;
the second magnetic circuit is an integrally magnetized magnet and comprises a second annular inner magnet, a second annular outer magnet, and a non-magnetic portion, the second annular inner magnet is spaced apart from the second annular outer magnet, and the non-magnetic portion is disposed between the second annular inner magnet and the second annular outer magnet; and
both the first annular inner magnet and the second annular inner magnet are magnetized along the direction of the optical axis of the lens, a magnetization direction of the first annular inner magnet is the same as a magnetization direction of the second annular inner magnet, both the first annular outer magnet and the second annular outer magnet are magnetized along the direction of the optical axis of the lens, a magnetization direction of the first annular outer magnet is the same as a magnetization direction of the second annular outer magnet, and the magnetization direction of the first annular inner magnet is opposite to the magnetization direction of the first annular outer magnet.

4. The optical imaging device according to claim 1, wherein the magnetic circuit system comprises a first magnetic circuit and a second magnetic circuit, the first magnetic circuit and the second magnetic circuit are overlapped along the direction of the optical axis of the lens, and the first magnetic circuit is closer to the at least one driving coil than the second magnetic circuit;
the first magnetic circuit comprises a first annular inner magnet and a first annular outer magnet, and the first annular inner magnet is spaced apart from the first annular outer magnet;
the second magnetic circuit comprises a second annular inner magnet and a second annular outer magnet, and the second annular inner magnet and the second annular outer magnet are interconnected; and
both the first annular inner magnet and the second annular inner magnet are magnetized along the direction of the optical axis of the lens, a magnetization direction of the first annular inner magnet is the same as a magnetization direction of the second annular inner magnet, both the first annular outer magnet and the second annular outer magnet are magnetized along the direction of the optical axis of the lens, a magnetization direction of the first annular outer magnet is the same as a magnetization direction of the second annular outer magnet, and the magnetization direction of the first annular inner magnet is opposite to the magnetization direction of the first annular outer magnet.

5. The optical imaging device according to claim 1, wherein the magnetic circuit system is an integrally magnetized magnet and comprises an annular inner magnet, an annular outer magnet, and a non-magnetic portion, the annular outer magnet is spaced apart from the annular inner magnet, and the non-magnetic portion is disposed between the annular inner magnet and the annular outer magnet; and
both the annular inner magnet and the annular outer magnet are magnetized along the direction of the optical axis of the lens, and a magnetization direction of the annular inner magnet is opposite to a magnetization direction of the annular outer magnet.

6. The optical imaging device according to claim 1, wherein the magnetic circuit system is an integrally magnetized magnet and comprises an annular inner magnet, an annular outer magnet, and an intermediate magnetic portion, and the intermediate magnetic portion is disposed between the annular inner magnet and the annular outer magnet;
both the annular inner magnet and the annular outer magnet are magnetized along the direction of the optical axis of the lens, and a magnetization direction of the annular inner magnet is opposite to a magnetization direction of the annular outer magnet; and
the intermediate magnetic portion is magnetized along the direction perpendicular to the optical axis of the lens, and a polarity of a surface of the intermediate magnetic portion close to the annular outer magnet is the same as a polarity of a surface of the annular outer magnet facing the lens.

7. The optical imaging device according to claim 1, wherein the elastic support component comprises a first connecting portion, a second connecting portion, and a third connecting portion;
the first connecting portion is connected to the bottom wall of the housing, the second connecting portion is connected to the image sensor assembly, the third connecting portion is connected to both the first connecting portion and the second connecting portion, and the third connecting portion extends along the side wall of the housing;
the first connecting portion is bent from the third connecting portion and extends along the bottom wall of the housing; and
the second connecting portion is bent from the third connecting portion and extends along a surface of the image sensor assembly.

8. The optical imaging device according to claim 7, wherein the third connecting portion is frame-shaped, the first connecting portion is bent from an outer side of the third connecting portion and horizontally extends outward, and the second connecting portion is bent from an inner side of the third connecting portion and horizontally extends inward.

9. The optical imaging device according to claim 7, wherein the third connecting portion is frame-shaped, both the first connecting portion and the second connecting portion are bent from an inner side of the third connecting portion and horizontally extend inward.

10. The optical imaging device according to claim 7, wherein first reinforcing sheets are disposed at bent portions of at least one of the first connecting portion and the second connecting portion.

11. The optical imaging device according to claim 7, wherein the third connecting portion is frame-shaped; and
the optical imaging device comprises a second reinforcing sheet, the second reinforcing sheet is disposed at at least one of an inner side and an outer side of each of bent portions of the third connecting portion.

12. The optical imaging device according to claim 1, wherein the bracket comprises a frame and a circuit board, the frame is connected to the elastic support component, and the circuit board is disposed on the frame and electrically connected to the elastic support component; and
the image sensor chip is disposed on the circuit board and electrically connected thereto.

13. The optical imaging device according to claim 7, wherein the bracket comprises a frame and a circuit board, the frame is connected to the elastic support component, and the circuit board is disposed on the frame and electrically connected to the elastic support component;
a side wall of the frame comprises bent transition portions, the elastic support component is connected to the bent transition portions to suspend the frame in the accommodating space; and
the second connecting portion is bent from the third connecting portion at the bent transition portions and extends toward the optical axis of the lens.

14. The optical imaging device according to claim 13, wherein the frame defines a mounting cavity at a first side thereof facing the bottom wall of the housing, and the mounting cavity is configured to accommodate the at least one driving coil or the magnetic circuit system;
the frame further comprises a support portion at a second side thereof facing the top wall of the housing, the support portion is configured to support the circuit board; and
the support portion and the mounting cavity are communicated through an opening, the first connecting portion is disposed at the opening, and a surface of the second connecting portion facing the circuit board is flush with a surface of the support portion.

15. The optical imaging device according to claim 12, wherein the image sensor assembly further comprises a filter and a support frame, the support frame is configured to support the filter; and
the filter is disposed between the lens and the image sensor chip, the support frame covers the image sensor chip and is disposed on the circuit board.

16. The optical imaging device according to claim 3, wherein four driving coils are provided, each correspondingly spaced apart from the first magnetic circuit, and are circumferentially spaced along the first magnetic circuit; and
a winding hole of each of the four driving coils is disposed corresponding to a gap region between the first annular inner magnet and the first annular outer magnet.

17. The optical imaging device according to claim 5, wherein four driving coils are provided, each correspondingly spaced apart from the magnetic circuit system, and are circumferentially spaced along the magnetic circuit system; and
a winding hole of each of the four driving coils is disposed corresponding to the non-magnetic portion.

18. The optical imaging device according to claim 6, wherein four driving coils are provided, each correspondingly spaced apart from the magnetic circuit system, and are circumferentially spaced along the magnetic circuit system; and
a winding hole of each of the four driving coils is disposed corresponding to the intermediate magnetic portion.

19. The optical imaging device according to claim 2, wherein the magnetic circuit system is an integrally magnetized magnet and comprises an annular inner magnet, an annular outer magnet, and a non-magnetic portion, the annular outer magnet is spaced apart from the annular inner magnet, and the non-magnetic portion is disposed between the annular inner magnet and the annular outer magnet; and
both the annular inner magnet and the annular outer magnet are magnetized along the direction of the optical axis of the lens, and a magnetization direction of the annular inner magnet is opposite to a magnetization direction of the annular outer magnet.

20. The optical imaging device according to claim 2, wherein the magnetic circuit system is an integrally magnetized magnet and comprises an annular inner magnet, an annular outer magnet, and an intermediate magnetic portion, and the intermediate magnetic portion is disposed between the annular inner magnet and the annular outer magnet;
both the annular inner magnet and the annular outer magnet are magnetized along the direction of the optical axis of the lens, and a magnetization direction of the annular inner magnet is opposite to a magnetization direction of the annular outer magnet; and
the intermediate magnetic portion is magnetized along the direction perpendicular to the optical axis of the lens, and a polarity of a surface of the intermediate magnetic portion close to the annular outer magnet is the same as a polarity of a surface of the annular outer magnet facing the lens.
